(19) United States
(12) Patent Application Publication
(10) Pub. No.: US 2014/0143042 A1
(43) Pub. Date: May 22, 2014

(54) Modeling Consumer Marketing

(71) Applicant: BANK OF AMERICA CORPORATION, Charlotte, NC (US)

(72) Inventors: Aditya Bhasin, Charlotte, NC (US); Paul W. Kunkel, El Dorado Hills, CA (US); Marc Jarmosevich, Charlotte, NC (US); Michael F. Petkus, Flower Mound, TX (US); Jason K. Springer, Woodland Hills, CA (US); Randy N. Elden, Bucksport, ME (US)

(73) Assignee: BANK OF AMERICA CORPORATION, Charlotte, NC (US)

(21) Appl. No.: 13/682,370

(22) Filed: Nov. 20, 2012

(51) Int. Cl. G06Q 30/02

(52) U.S. Cl. CPC G06Q 30/0242
USPC 705/14.41

(57) ABSTRACT

Consumer behavior may be modeled to measure the effectiveness of consumer marketing campaigns and to calculate the effect of other factors driving consumer behavior in the same markets. A dependent variable, such as product sales, product uses, or customer indications of interest in a product or business, may be associated with a marketing campaign potentially affecting the dependent variable. Data corresponding to the dependent variable for a plurality of markets over a period of time prior to a marketing campaign may be received and analyzed. A market matching process may be performed using the dependent variable data before the start of the marketing campaign, and a difference may be calculated between sets of matching markets for the dependent variable during the marketing campaign. An econometric modeling process may be performed on the calculated difference between the sets of matching markets, to measure the effectiveness of the marketing campaign and calculate the effect of other driving factors.

### TECHNICAL FIELD

Aspects of the disclosure generally relate to computer systems, computing devices, and computer software for modeling consumer behavior and the effect of consumer marketing. In particular, one or more aspects of the disclosure relate to computer systems, computing devices, and computer software that may be used to measure the effectiveness of consumer marketing campaigns and calculate the effect of various other factors driving consumer behavior in the same markets.

### BACKGROUND

Statistical data modeling techniques for consumer marketing can provide the tools to measure the effectiveness of marketing campaigns, as well as provide valuable insights into the drivers of consumer behaviors. Understanding why certain marketing campaigns are successful while others are unsuccessful can provide great value to businesses, but there are also significant challenges to creating and executing accurate statistical models of consumer behavior and the effect of consumer marketing campaigns. A new advertising campaign that encourages consumers in a city to buy a product may coincide with a 5% sales increase for the product in that city. However, it may be an overly simplistic and flawed analysis to draw a conclusion based on this data that the advertising campaign was responsible for the sales increase. Many other factors may have been involved in driving the increase in sales of the product, for example, changes in the national or local economy, the time of year, changes in local weather conditions, changes in prices of complementary or competing products, or increases or decreases in the marketing campaigns of competitors, to name just a few of the possible factors. In many cases, these other factors may affect the sales of the product much more than the marketing campaign. A marketing campaign may be very effective and successful even if overall product sales decrease during the campaign, for example, if sales would have decreased even more had the campaign not been run. Similarly, an ineffective marketing campaign may coincide with an increase in sales caused by other factors, even though the marketing campaign may have contributed little or nothing to the increase in sales.

The effectiveness of consumer marketing campaigns can be measured more easily for certain types of marketing campaigns than for others. A direct-mail campaign may send advertisements that include a telephone number, web site address, or other identifier (e.g., a discount code) that the advertiser can use to determine when a customer responded directly to the mailed advertisement. Additionally, web-based advertisers may track ‘clicks,’ and the number of sales resulting from those clicks, to measure the effectiveness of specific web-based ads. However, for mass media marketing campaigns, such as television, print, and radio advertisements, direct data that links a customer or purchase to a specific advertisement or marketing campaign may not be available. Moreover, even when direct data is available linking an advertisement to a customer purchase, the advertisement may have been incidental, and other factors such as those mentioned above may have had more to do with the customer's decision to purchase the product.

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to computer systems, computing devices, and computer software for modeling consumer behavior, measuring the effectiveness of consumer marketing campaigns, and calculating the effect of other various factors driving consumer behavior in the same markets. In certain embodiments, a dependent variable, such as product sales, product uses, or customer indications of interest in a product or business, may be associated with a marketing campaign potentially affecting the dependent variable. Data corresponding to the dependent variable for a plurality of markets over a period of time prior to the marketing campaign may be received and analyzed. A market matching process may be performed using the received data, in which a set of one or more priority markets is matched to a set of one or more non-priority markets for the dependent variable over a period of time prior to the marketing campaign. After the market matching process, a difference may be calculated between the sets of matching markets for the dependent variable over a period of time during the marketing campaign. An econometric modeling process may be performed on the calculated difference between the sets of matching markets, and based on the econometric modeling process a contribution of the marketing campaign to the calculated difference between the sets of matching markets for the dependent variable may be determined.

In other aspects of the disclosure, additional independent variables other than the marketing campaign may be identifying and analyzed using the econometric modeling process, to determine the contribution of the additional independent variables on the difference between the sets of matching markets for the dependent variable. One or more independent variables may drive the difference between the sets of matching markets for the dependent variable only after the start of the marketing campaign, while other independent variables may drive the difference between the sets of matching markets for the dependent variable before and after the start of the marketing campaign. According to additional aspects of the disclosure, indexes of the dependent variable may be created and stored for each of the priority and non-priority markets during the market matching process, and indexes of the differences between the priority and non-priority markets for the dependent variable may be created and stored during the econometric modeling process.

### BRIEF DESCRIPTION OF THE DRAWINGS

The present disclosure is illustrated by way of example and not limited in the accompanying figures in which like reference numerals indicate similar elements and in which:

FIG. 1 illustrates an example computing environment in which various aspects of the disclosure may be implemented.

FIG. 2 is a flow diagram illustrating an example computer modeling process for consumer behavior and effectiveness of a consumer marketing campaign in accordance with one or more illustrative aspects described herein.

FIGS. 3A and 3B are data charts containing example indexed market data for a plurality of priority markets and a plurality of dim markets, respectively, in accordance with one or more illustrative aspects described herein.

FIGS. 4A and 4B respectively illustrate an example list of all priority and dim markets, and a chart comparing the combined indexed values for all of the priority markets and the combined indexed values for all of the dim markets, in accordance with one or more illustrative aspects described herein.

FIGS. 5A and 5B respectively illustrate an example list of matched sets of priority and dim markets, and a chart comparing the combined indexed values for the set of priority markets and the combined indexed values for the set of matching dim markets, in accordance with one or more illustrative aspects described herein.

FIGS. 6A and 6B are bar graphs illustrating examples of differences in consumer marketing campaign spending between priority and dim markets, and differences in consumer marketing campaign spending between priority, normal, and dim markets, respectively, in accordance with one or more illustrative aspects described herein.

FIG. 7 is a line graph illustrating spending differences between matched priority and dim markets for three example consumer marketing campaigns, and a difference in a measured dependent variable between the matched priority and dim markets, in accordance with one or more illustrative aspects described herein.

FIG. 8 is a bar graph illustrating an example set of independent variables driving a difference in a measured dependent variable between matched priority and dim markets, in accordance with one or more illustrative aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

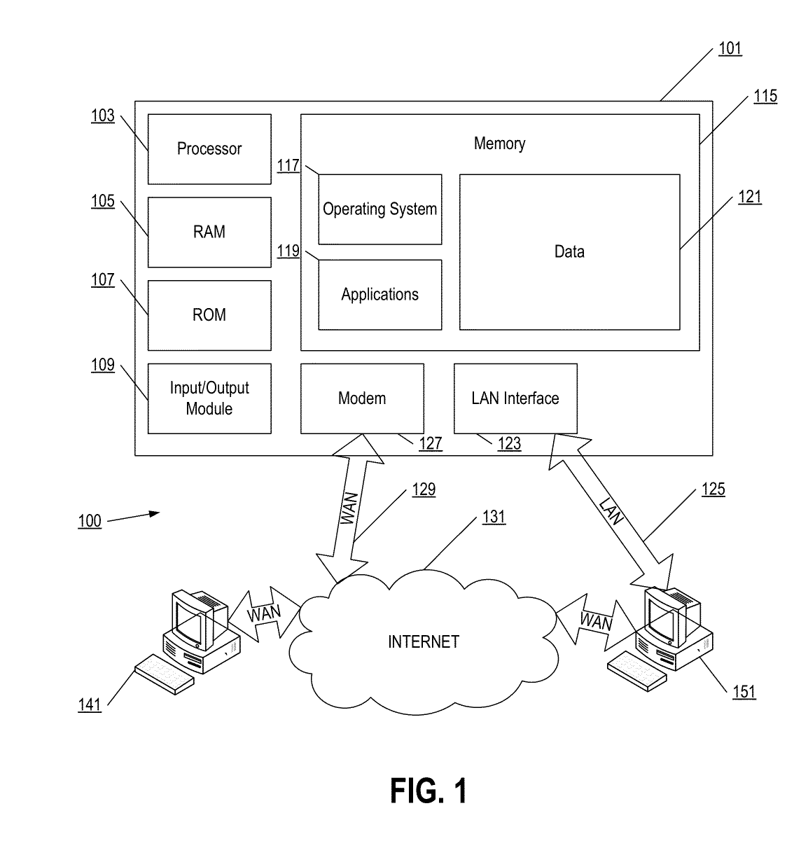

FIG. 1 illustrates an example block diagram of a computer system 101 (e.g., a computer server or other computing device) in an example computing environment 100 that may be used in one or more illustrative embodiments of the disclosure. The computer system 101 may comprise a generic computing device including specialized computer software to perform statistical modeling of consumer behavior and consumer marketing campaigns. Computer system 101 may also comprise specialized computer hardware configured to receive market data input, process the market data and execute statistical computer modeling techniques on the data, and determine and output the results of the statistical modeling processes via the computer system 101.

The computer system 101 may have a processor 103 for controlling overall operation of the system and its associated components, including random access memory (RAM) 105, read-only memory (ROM) 107, input/output (I/O) module 109, and memory 115. I/O module 109 may include a keyboard, keypad, mouse, touch screen, scanner, optical reader, stylus, and/or other peripheral devices for receiving user input. The I/O module 109 also may include one or more associated mobile devices configured to connect and communicate with the system 101 via RF wireless transceivers to provide and receive data from the system 101. The I/O module 109 may also include one or more of a speaker for providing audio output and a video display device for providing textual, audiovisual, and/or graphical output. Specialized software may be stored within memory 115 and/or other storage to provide instructions to processor 103 for enabling the computer system 101 to perform various functions described herein relating to statistical computer modeling of consumer behavior and consumer marketing campaigns. For example, memory 115 may store software used by the computer system 101, such as an operating system 117, application programs 119, and an associated database 121. Alternatively, some or all of the computer executable instructions for generic computing device 101 may be embodied in hardware or firmware (not shown).

The computer system 101 may operate in a networked environment supporting connections to one or more remote computers, such as terminals 141 and 151. The terminals 141 and 151 may be personal computers or servers that include many or all of the elements described above with respect to the computer system 101. The network connections depicted in FIG. 1 include a local area network (LAN) 125 and a wide area network (WAN) 129, but may also include other networks. When used in a LAN networking environment, the computer system 101 may be connected to the LAN 125 through a network interface or adapter 123. When used in a WAN networking environment, the computer system 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computer system 101 and/or terminals 141 or 151 may be incorporated into numerous general purpose or special purpose computing system environments or configurations. Examples of well-known computing systems, environments, and/or configurations that may be suitable for use with systems described herein include, but are not limited to, computer servers, personal computers, clients or servers in a web-based environment, laptop computing devices, mobile terminals (e.g., mobile phones, smartphones, PDAs, notebooks, etc.), multiprocessor systems, microprocessor-based systems, programmable consumer electronics, network PCs, minicomputers, mainframe computers, distributed computing environments that include any of the above systems or devices, and the like.

Having described a computer system 101 and a computing environment 100 in FIG. 1, on which various techniques for statistical computer modeling of consumer behavior and consumer marketing campaigns may be performed, the following paragraphs describe embodiments and examples of modeling processes for consumer marketing in greater detail.

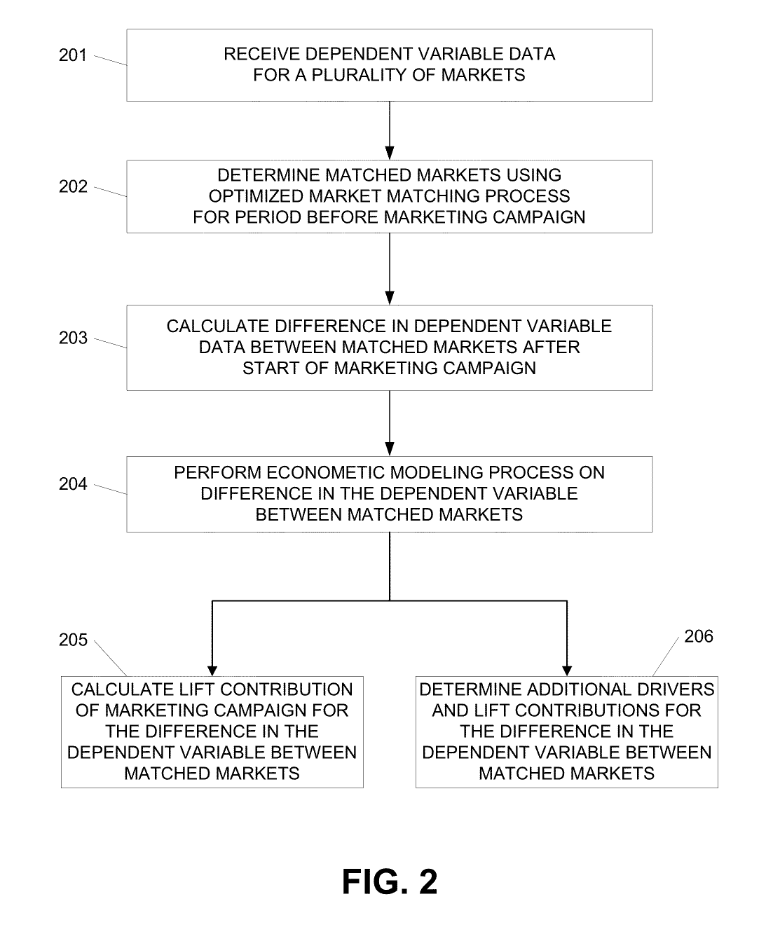

Referring now to FIG. 2, a flow diagram is shown illustrating an example statistical modeling process for consumer behavior and effectiveness of a consumer marketing campaign. The example modeling process illustrated in FIG. 2, and the various examples and embodiments described below, may be performed on a consumer marketing modeling system that may include many or all of the elements described above with respect to the computer system 101.

In step 201, a computer statistical modeling system 101 for consumer behavior and consumer marketing may receive market data corresponding to a dependent variable for a plurality of markets. As used herein, the term “dependent variable” refers to measurable consumer behavior that potentially may be affected by a consumer marketing campaign. For example, a dependent variable may be a measurement of a number of products (or services) purchased by consumers. Sales of consumer products, such as a menu item at a restaurant, a type of vehicle sold by a car dealer, an airplane ticket sold by an airline, a visit to a doctor's office, or a long-distance telephone calling plan, may be said to be “dependent” variables because a customer's decision to purchase or not to purchase the product depends on a number of “independent” factors, such as a consumer marketing campaign for the product or service. Other independent factors may include, for example, the customer's discretionary income, the price and availability of the product, local and national economic factors, the customer's age and demographic profile, the prices and marketing campaigns of complementary or competing products, among other independent factors.

Dependent variables may include other consumer behaviors besides product purchases. For example, dependent variables that may be affected by a consumer marketing campaign include uses of a previously purchased product, indications of interest in the product or the business offering the product (e.g., inquiry calls, clicks on a web site advertisement), requests for information (e.g., enrollment in email notifications for product information, pricing, or discount alerts), cancellations of previous requests for information, and/or decisions to purchase or not purchase complementary or competing products. For example, a bank or financial institution may offer a wide variety of products to customers, such as banking products (e.g., new bank accounts, transactions at the bank's automated teller machines (ATMs)), credit products (e.g., a new credit cards), investment products (e.g., new investment/trading accounts), insurance products (e.g., new insurance policies), and home financing services (e.g., financing or refinancing home mortgages, home improvement or repair loans), each of which potentially may be affected by consumer marketing campaigns. In addition to these financial products, a bank or financial institution may have other measurable data, such as customer uses of its products (e.g., the numbers of purchases/swipes made with the bank's debit or credit cards, the number of checks written on the bank's accounts, the numbers of deposits or withdrawals by customers into the bank's accounts, the numbers of trades by customers using the bank's investment accounts, etc.). Banks also may measure “primacy” among its customers, that is, the number of customers that use the bank as their primary banking institution, rather than merely maintaining an account at the bank. As an example, one measure of primacy may be defined as the number of households having checking accounts with the bank, in which monthly deposits above a deposit threshold (e.g., $750), and monthly debits (e.g., checks, debit card transactions, automatic bill payment, automatic clearing house (ACH) transactions, etc.) are performed for at least three consecutive months. In this example, any of these financial products (or combinations of products), uses of those products, and any other measurable statistics (e.g., household primacy among customers) may be defined as dependent variables, in that they are measurable consumer behavior that potentially may be affected by a consumer marketing campaign of the bank or financial institution.

The market data received by the statistical modeling computer system 101 in step 201 may correspond to one or more dependent variables (e.g., purchases of products or services, uses of previously purchased products or services, indications of customer interest, or other measurable business data) for a plurality of different markets. Markets may correspond to different geographic markets (e.g., cities, states, or countries) and/or different demographic markets (e.g., gender-specific, age-specific, etc.) in which the dependent variable can be measured. For example, the statistical modeling computer system 101 may receive monthly home mortgage refinancing data for a number of different cities, in order to model the customer's decision to refinancing a home mortgage (the dependent variable) based on the bank's marketing campaign as well as the other independent factors that may drive the customer's decision to refinance.

The statistical modeling computer system 101 may receive the market data in step 201 from one or more additional computer systems (e.g., terminals 141 and 151). In certain examples, the system 101 may receive a request to perform a computer statistical modeling process for a dependent variable, and may receive the market data corresponding to the dependent variable from the same source. In other examples, the statistical modeling computer system 101 may identify the dependent variable, and then may retrieve the market data from one or more additional computer systems, for example, by initiating communication with various database systems (e.g., marketing databases, sales databases) and retrieving data for a plurality of markets using database queries. Market data also may be received by the system 101 by user input, from one or more peripheral computing devices (e.g., keyboard) in I/O 109, or one more mobile devices configured to connect with the system 101 and wirelessly transmit the market data.

In step 202, the statistical modeling computer system 101 may analyze the market data received in step 201 in order to determine sets of matched markets for a period of time before the beginning of a marketing campaign. The term “matched markets” as used herein refers to different markets (e.g., cities) that have relatively similar behavior with respect to a dependent variable over a specified period of time. For example, when analyzing consumer purchases of a product, sales data from two different cities (City A and City B) may reflect that purchases in those cities have changed at similar rates over a period of time. The similarity between City A and City B in product purchase rates may indicate that at least some of the factors driving the purchase rates of the product (e.g., economic conditions, supply and demand factors, seasonal weather factors, competition factors, etc.) may be similar in City A and City B, and that consumers in both cities may be reacting similarly to these factors. In contrast, the sales data from two different cities (City C and City D) may reflect much larger differences in the rates of purchases of the product. Thus, different factors may be driving the purchase rates of the product in City C and City D, and/or the consumers in these cities may be reacting differently to the factors driving purchasing. Although no two markets (or sets of markets) will behave in an identical manner for a dependent variable, the market data in this example indicates that City A and City B are better choices as matched markets for purchases of the product, as compared with City C and City D, because the changes in the product purchase rates in City A and City B track more closely over the relevant period of time.

In certain embodiments, the statistical modeling computer system 101 may match a set of (one or more) markets in which a marketing campaign is used, against a set of (one or more) different markets in which the marketing campaign is either not used or not used to the same extent. Markets in which a consumer marketing campaign that may affect a dependent variable is used to a greater extent are referred to herein as “priority markets.” Markets in which the same marketing campaign is used to a lesser extent, or is not used at all, are referred to herein as “non-priority markets” or “dim markets.” As discussed below, by matching one or more priority markets with one or more non-priority (or dim) markets during a time period before the start of the consumer marketing campaign, the statistical modeling computer system 101 may calculate the effect of the consumer marketing campaign in relation to other factors driving the dependent variable.

In some embodiments, the computer system 101 may perform statistical modeling of the consumer behavior with respect to the dependent variable (e.g., product sales) in order to identify the most relevant drivers of the dependent variable, but might not need to model the effect of a consumer marketing campaign. For example, the system 101 may use the statistical modeling techniques described herein to determine the relevant drivers of the dependent variable even if no specific marketing campaign has been used to drive the dependent variable, or if the same marketing campaign has been used (and used at the same magnitude) in all of the relevant markets. In these examples, the statistical modeling computer system 101 may still attempt to match two markets (or two sets of markets), but need not match priority markets to dim markets.

As discussed above, when analyzing market data in step 202 to determine a driving effect of a marketing campaign on an dependent variable (e.g., product sales), data from one or more priority markets may be matched to data from one or more dim markets. The statistical modeling computer system 101 may analyze the plurality of market data for a time period just prior to the beginning of the marketing campaign. In the case of an ongoing marketing campaign that has been increased in priority markets and/or decreased in dim markets, the system 101 may analyze the market data for the time period just prior to the increase or decrease. Therefore, the data analysis in the step 202 may allow the system 101 to identify optimally matching markets without respect to any effect on the dependent variable caused by the introduction of the marketing campaign (or change in the existing marketing campaign).

In order to match a set of priority markets to a set of dim markets, the relevant dependent variable data (e.g., product sales, product uses, customer indicates of interest, etc.) for each market may be indexed by the statistical modeling computer system 101 to a baseline value. For example, product sales data (e.g., daily, weekly, monthly, or yearly sales data) may be collected for each market over the same predetermined period of time (e.g., 1 month, 3 months, 6 months, 12 months, etc.). The dependent variable data for each market may be averaged over the entire period, and the average may be used as a common baseline value (e.g., 1.00) for each market. After establishing the average and the baseline for each market, calculations for the dependent variable may be performed for smaller units of time (e.g., days, weeks, months, etc.) within the period. The dependent variable for each of the smaller units of time may be calculated as a ratio or multiplier of the baseline value (1.00). For example, if product sales for one month during the period are 10% higher than the average, then the monthly sales figure may be recorded as 1.10. If the sales for the following month were 20% lower than the period average, then the monthly sales figure for that month may be recorded as 0.80.

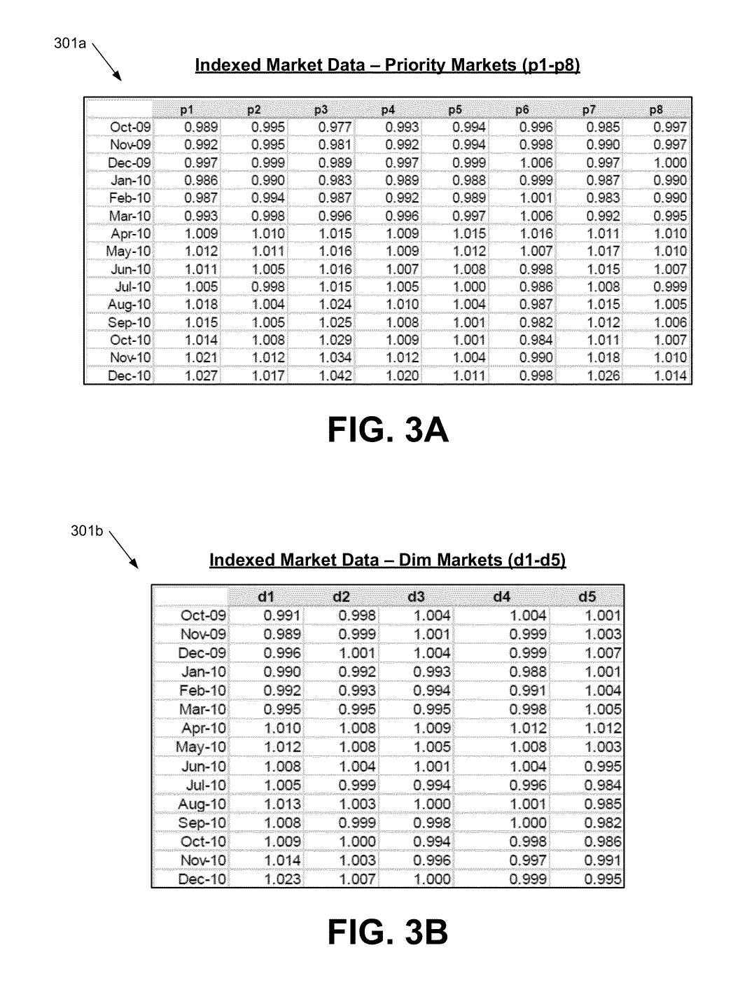

Referring now to FIGS. 3A and 3B, two example data charts 301a and 301b are shown containing indexed monthly market data for a sample period of time, October 2009 to December 2010. Charts 301a shows market data for a set of priority markets (p1-p8), for example, cities in which a marketing campaign was run after December 2010. Charts 301b shows market data for a set of dim markets (d1-d5), for example, cities in which the marketing campaign will not be run after December 2010. Both charts 301a and 301b contain monthly market data figures for a dependent variable (e.g., product sales), in which the monthly figures have been indexed to baseline average of 1.000, allowing the market data to be expressed on the same scale regardless of differences in size of the markets. For example, markets (p1-p8) in chart 301a and markets (d1-d5) in chart 302 may each correspond to different sized markets, ranging from very large to very small markets. Scale adjustments also may be performed for other factors besides market size. For example, market data may be scaled based on propensity for a given dependent variable as well.

In the data analysis of step 202, the statistical modeling computer system 101 may compare different combinations of priority markets with different combinations of dim markets, in order to determine an optimal market matching for the dependent variable. In certain embodiments, system 101 may compare the market data of each possible combination of priority markets to the market data of each possible combination of dim markets. For each comparison, the system 101 may identify a set of priority markets, then combine and average the indexed market data for each of the priority markets in the combination. Similarly, the system 101 may identify a set of dim markets, then combine and average the indexed market data for each of the dim markets in the combination. Then, the system 101 may compare the combined priority market data to the combined dim market data, and calculate the difference between the two combinations of markets. If the combined priority market data tracks relatively closely to the combined dim market data, then the two sets of markets (the priority market set and the dim market set) may potentially be an optimized matched market set. If the combined priority market data does not track closely to the combined dim market data, then the two sets of markets are not likely to be an optimized matched market set.

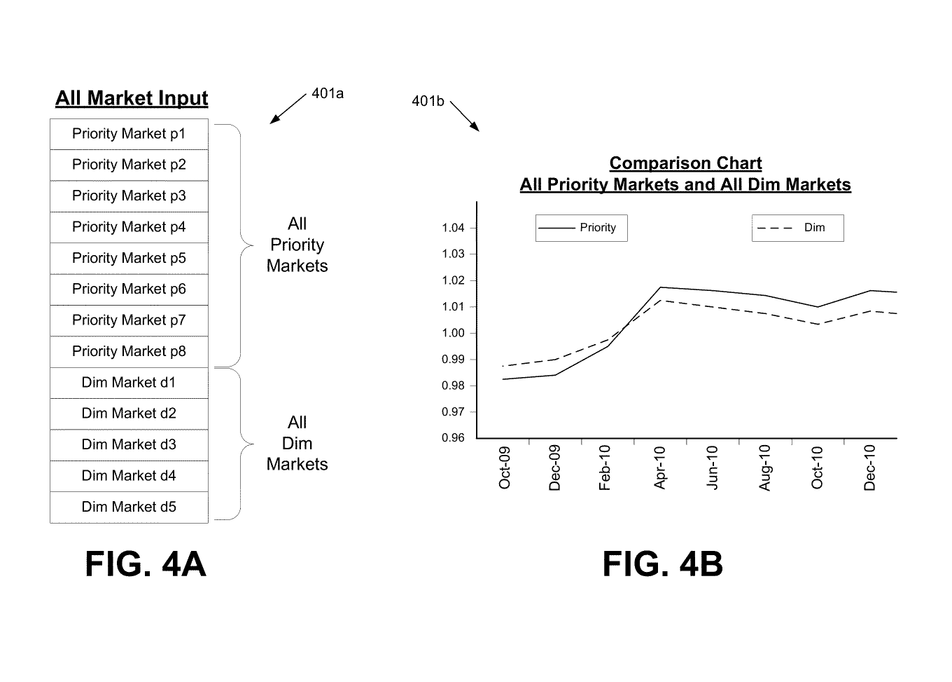

Referring now to FIG. 4A, an example market input list 401a is shown including all of the priority markets and all of the dim markets for which market data is available. In FIG. 4B, a line graph 401b is shown comparing the combined indexed values for all of the priority markets (p1-p8) with the combined indexed values for all of the dim markets (d1-d5). As shown in FIG. 4B, the two sets of markets (i.e., the set of all priority markets and the set of all dim markets) generally track one another with respect to the dependent variable during the time period from October 2009 to December 2010. However, the sets of priority and dim markets in graph 401b do not closely track each other during this time period, and thus are not optimally matched market sets in this example.

In order to identify to the sets of priority markets and dim markets which are optimally matched, the statistical modeling computer system 101 may combine and average the indexed market data for every possible combination of priority markets, and for every possible combination of dim markets. Each combination of priority markets and dim markets may then be compared to determine the set of priority markets and the set of dim markets that match each other most closely. The system 101 may execute an optimization routine to identify the best sets of priority markets and dim markets, corresponding to the sets of markets that look and behave most similarly with respect to the dependent variable during the pre-campaign period. An optimization routine may rank each combination based on a score, and either the system 101 or a user then may select a combination having the highest score or lowest rank to be used as the matching market sets. In certain examples, a constrained non-linear optimization process may be used, by minimizing the sum of the squared differences between the sets of trends, constrained by user defined minimum weights by market that sum to 1. Then the weighted combinations may be ranked by a score created as a combination of one times the mean absolute percent error (MAPE) of the difference in trends between sets of markets, measured on an out-of-time validation sample, plus two times MAPE stability (i.e., the difference in MAPE in-time versus out-of-time). Additionally, in some examples, a Euclidean distance calculation may be used to enhance the score and/or adjust the rank based on similarities/differences across a number of key profile variables simultaneously. During an optimization and ranking process, the system 101 may graphically chart the differences between the priority and dim market sets, as shown in FIG. 4B, or may calculate the differences between the priority and dim market sets by summing the absolute values of the differences between the priority and dim market sets at multiple various points in time, and/or using other statistical analysis techniques to determine the closest matching sets of markets.

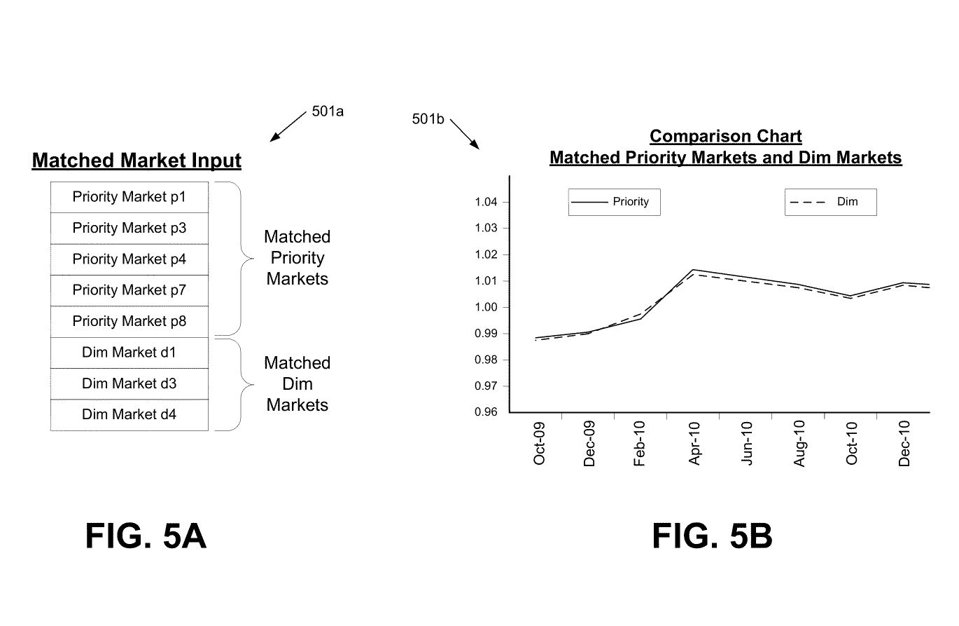

Referring now to FIG. 5A, an example market input list 501a is shown including matching sets of priority and dim markets. For this example, an optimization algorithm executed by the statistical modeling computer system 101 may have determined that the set of priority markets consisting of markets p1, p3, p4, p7, p8, matches the set of dim markets consisting of markets d1, d3, and d4, more closely than any other sets of priority and dim markets. In FIG. 5B, a line graph 501b is shown comparing the combined indexed values for the optimized matching sets of priority markets and dim markets. As shown in FIG. 5B, the two sets of markets track one another with respect to the dependent variable more closely than the complete set of markets shown in FIG. 4B.

In step 203, the statistical modeling computer system 101 may calculate the difference in the dependent variable (e.g., product sales) between the matched markets over a second period of time after the beginning of the consumer marketing campaign. The statistical modeling computer system 101 may use similar techniques to those described above to calculate the post-campaign differences in the dependent variable between the matched markets identified in step 202. The system 101 may retrieve the dependent variable market data for each priority and dim market identified in step 202, index the data for each market to a baseline value, and then combine and average the market data for the priority markets and separately for the dim markets. In certain examples, the indexing for each market may occur only once, and all of the dependent variable market data (i.e., pre-campaign and post-campaign data) may be averaged and indexed to a baseline value (e.g., 1.000), and then re-calculated as a ratio or multiplier of the baseline value. In other examples, pre-campaign and post-campaign dependent variable market data may be indexed separately for each market.

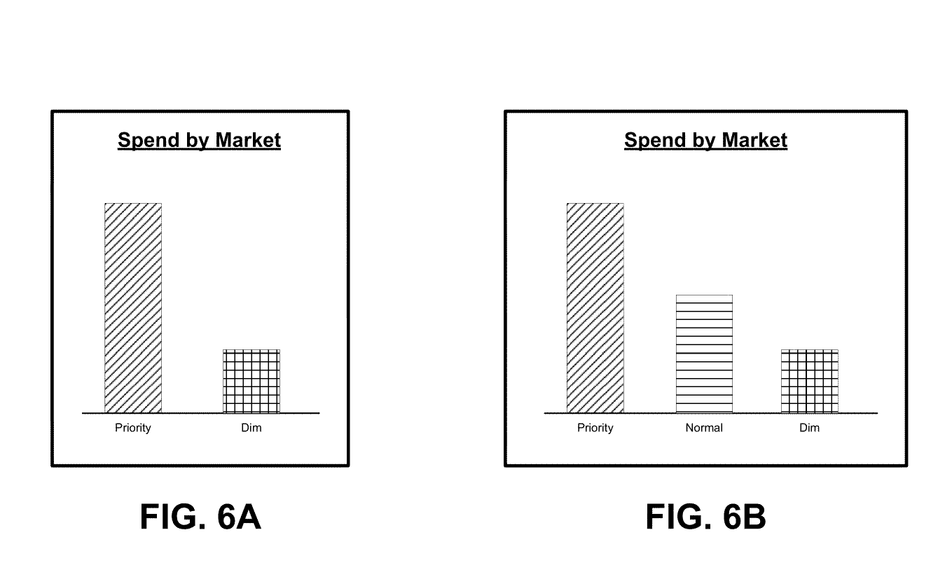

Referring now to FIGS. 6A and 6B, two bar graphs are shown illustrating an example of the spending level differences between priority markets and non-priority markets during a consumer marketing campaign. The spending levels in this example may refer to normalized and scaled spending levels, based on the size of the markets (e.g., scaled based on total population, TV viewing households, etc.) and the cost of advertising within the markets, rather than overall dollars spent. For example, Los Angeles, Calif., may be a dim market for a certain marketing campaign, and Springfield, Mass., may be a priority market for the same campaign, even though more total dollars may be spent in the larger and more expensive Los Angeles market. As shown in FIG. 6A, the marketing campaign in this example is deployed in the dim markets, but at a scaled spending level lower than the spending level of the priority markets. In other examples, the marketing campaign might not be used at all in the dim markets, and the spending level in those markets may be zero.

As shown in FIG. 6B, markets may be classified into more than two different spending levels, rather than just priority and dim markets. In this example, the markets are classified into three spending levels: normal markets having a baseline level of spending during the marketing campaign; priority markets in which more than the baseline level of spending has been spent during the marketing campaign; and dim markets in which less than the baseline level of spending has been spent during the marketing campaign as compared to the normal spending levels. In this example, the normal and dim markets may be considered “non-priority” markets. In such examples in which more than two different spending levels are used and tracked, the statistical modeling computer system 101 may use the different spending levels to perform various additional functions relating to modeling consumer behavior and measuring the effectiveness of consumer marketing campaigns. For example, the system 101 may track changes in consumer behaviors and/or campaign effectiveness in response to smaller or larger increases or decreases in campaign spending amounts. In such examples, the system 101 may determine an optimal spending distribution across multiple different marketing campaigns in multiple different markets, to maximize the overall marketing effectiveness of a product or business.

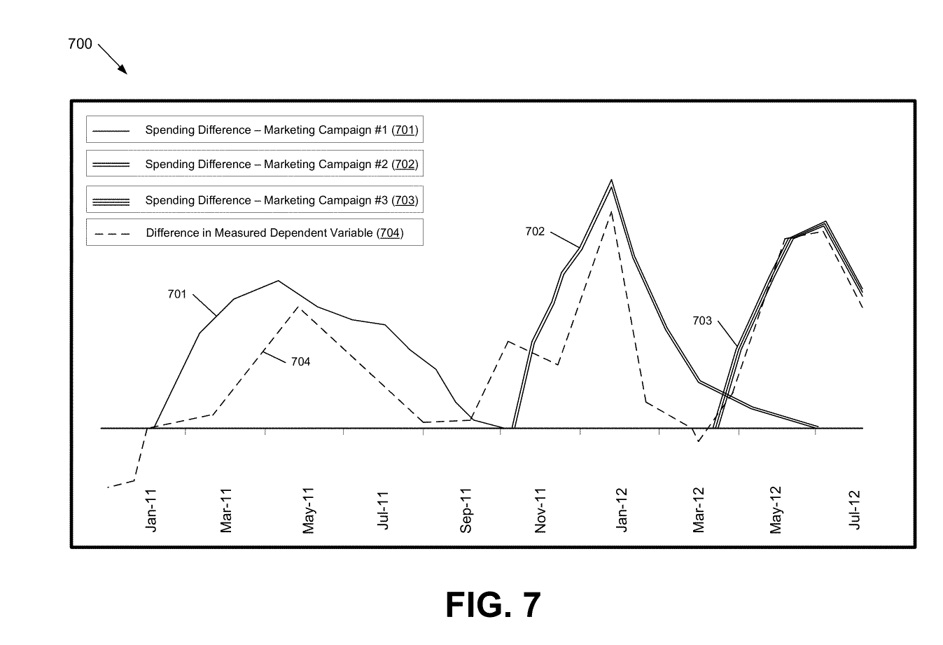

Referring now to FIG. 7, a line graph 700 is shown illustrating the differences in spending between matched priority and dim markets for three example consumer marketing campaigns, as well as a difference in a measured dependent variable (e.g., product sales) between the matched priority and dim markets during the same time period. In this example, line 701 represents a difference in spending levels between the matching sets of priority markets and dim markets for a first marketing campaign taking place between January 2011 and October 2011. Line 702 represents a difference in spending levels between the matching sets of priority markets and dim markets for a second marketing campaign taking place between October 2011 and June 2012. Line 703 represents a difference in spending levels between the matching sets of priority markets and dim markets for a third marketing campaign taking place between March 2012 and at least July 2012. Line 704 represents the difference in the measured dependent variable (e.g., product sales) between the matching sets of priority markets and dim markets between January 2011 and July 2012.

The statistical modeling computer system 101 may calculate the spending level differences 701-703 by averaging the scaled spending levels, at specific points in time, for the matched priority markets and the matched dim markets. The difference between the average matched priority market spending difference and the average matched dim market spending difference, at the specific time, may correspond to a point on one of the lines 701-703. Similarly, the difference 704 in the measured dependent variable may be calculated by indexing the dependent variable data separately for each of the priority markets and each of the dim markets, and then averaging the indexed dependent variable measurements for the priority markets and separately for the dim markets. The difference between the average indexed priority market dependent variable and the average indexed dim market dependent variable, at a specific time, may correspond to a point on line 704. By averaging the differences in scaled spending levels in the marketing campaigns 701-703, and by indexing and averaging the differences in the dependent variable 704, the values in chart 700 may correspond to ratios (e.g., percentage changes in campaign spending or a dependent variable from a baseline amount) rather than overall values. Thus, the differences between the sets of priority markets and dim markets may be compared on the same scale regardless of differences in sizes between the combined priority markets and the combined dim markets.

As seen in FIG. 7, line 704 (the difference in the dependent variable between the priority and dim matched markets) somewhat tracks line 701 (the spending difference in the first marketing campaign between the priority and dim matched markets), more closely tracks line 702 (the spending difference in the second marketing campaign between the priority and dim matched markets), and still more closely tracks line 703 (the spending difference in the third marketing campaign between the priority and dim matched markets). As discussed in greater detail below, the statistical modeling computer system 101 may determine based on these relationships (1) that a significant portion of the measured differences between the matched priority and dim markets may be attributable to the consumer marketing campaigns, and (2) that the third marketing campaign was the most effective driver of the dependent variable, followed by the second marketing campaign, followed by the first marketing campaign. Because lines 701-704 represent differences between sets of priority and dim markets that have been previously matched with respect to the dependent variable, many of the independent variables (i.e., drivers) that may affect the dependent variable have already been controlled for in this example. Thus, the differences illustrated in graph 700, between the marketing campaign lines 701-703 and the dependent variable line 704, may more accurately identify the relationships between the marketing campaigns and the dependent variable, in comparison to models in which the measured differences are not differences between previously matched markets.

In step 204, the statistical modeling computer system 101 may perform an econometric modeling process on the post-campaign differences calculated in step 203 between the matched priority and dim markets. Econometric modeling techniques (e.g., linear regression, cointegration, etc.) are related forms of statistical modeling. In step 204, a number of independent variables may be individually identified, tested, analyzed, and measured using various econometric modeling techniques, in order to determine the contribution made by the independent variable to the difference between the matched priority and dim markets for the dependent variable. As discussed above, a significant portion of the measured differences between the matched priority and dim markets for the dependent variable may be attributable to the consumer marketing campaigns, because the markets were matched based on the dependent variable prior to the start of the marketing campaigns.

However, other independent variables (or drivers) besides the marketing campaigns may contribute to the differences in the dependent variable between the matched markets. One reason for this is that during the market matching processes performed in step 202, it is unlikely that the statistical modeling computer system 101 will perfectly match sets of priority and dim markets. Even if the system 101 identifies optimal or near-optimal matching markets, there still may be some pre-campaign differences between the matched markets. See, e.g., FIG. 5B. These pre-campaign differences are the results of other independent variables that were could not be or were not controlled for during the market matching process, and thus are likely to continue to affect the difference in the dependent variable after the marketing campaign commences. Another independent variable that may drive post-campaign differences in the dependent variable between the matched markets may be the result of an independent event that occurs after the start of the marketing campaigns. As an example, a severe weather event or a local economic change may occur after start of the marketing campaign in one of the matched markets, but not in others. In this example, such events may be independent variables driving differences in the dependent variable between the matched markets (i.e., by affecting one matched market differently than other matched markets). Additionally, these independent variables could not be controlled for by the market matching process in step 202, because the events occurred after the time period used for the market matching process (i.e., a time period prior to the start of the marketing campaign).

Therefore, in step 204, each potential independent variable driving a difference between the dependent variable in the matched markets, may be tested, modeled, and analyzed using an econometric modeling process performed by the statistical modeling computer system 101. During the econometric modeling process of step 204, the independent variables may be indexed to a pre-campaign period of time, and the difference in the indexed values of the independent variables on the priority versus dim market combinations, weighted by market size, may be used to predict indexed differences in the dependent variable. Then, by comparing the predicted indexed differences in the dependent variable to the actual post-campaign differences in the dependent variable observed in step 203, the system 101 may determine a percentage of the difference between the dependent variable in the priority and dim matched markets that is attributable to each independent variable (i.e., a “lift contribution”), along with a confidence probability associated with each lift contribution calculation.

Referring to step 205, the econometric modeling techniques performed in step 204 may allow the system 101 to calculate the relationship between the marketing campaign (or campaigns) and the difference in the dependent variable between the matched markets. Additionally, referring to step 206, the system 101 may perform similar econometric modeling techniques on other independent variables to identify other drivers of the difference in the dependent variable between the matched markets, and to determine a lift contribution for those additional drivers. Steps 205 and 206 may result from similar or identical econometric modeling techniques performed by the statistical modeling computer system 101 in step 204. That is, econometric modeling techniques used to determine lift contribution percentages and confidence levels of marketing campaigns may similarly be used to determine lift contribution percentages and confidence levels of other independent variables that may be affecting the dependent variable.

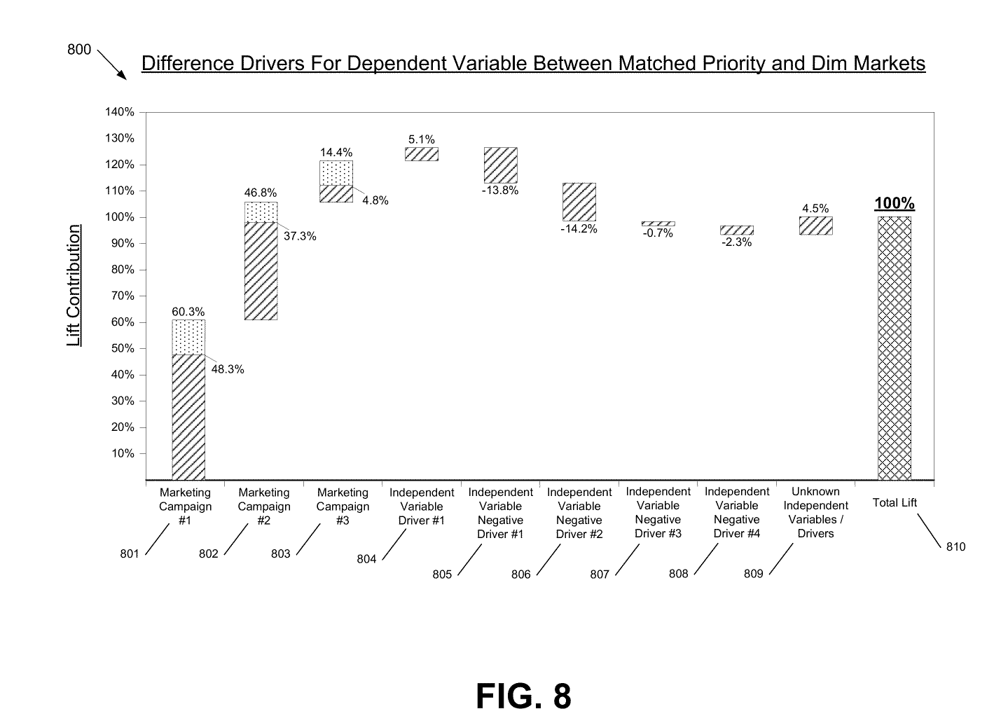

Referring now to FIG. 8, an example bar graph 800 is shown illustrating a set of independent variables 801-808 that drive the difference in a dependent variable (e.g., product sales) between matched sets of priority markets and dim markets. In this example, the econometric modeling techniques of step 204 (e.g., linear regression, cointegration, etc.) may be used to test and analyze each of the independent variables 801-808, among other independent variables, in order to determine which independent variables contribute to the difference in the dependent variable between the matched markets, and by how much. Independent variables 801, 802, and 803 correspond to three separate marketing campaigns. The statistical modeling computer system 101 may use econometric modeling techniques to analyze each of the marketing campaigns 801-803, and to calculate lift contribution percentages for each of the marketing campaigns 801-803, along with statistical probabilities for the calculated lift contributions. In this example, the statistical modeling computer system 101 may execute an econometric model for the first marketing campaign 801, calculating an estimated lift percentage of 60.3% for the first marketing campaign 801, including a 95% confidence level that the first marketing campaign 801 drove at least 90% of the calculated lift (i.e., 48.3%). For the second marketing campaign 802, the system 101 may execute a similar econometric model to calculate an estimated lift percentage of 46.8%, including a 95% confidence level that the second marketing campaign 802 drove at least 90% of the calculated lift (i.e., 37.3%). Similarly, for the third marketing campaign 803, the system 101 may calculate an estimated lift percentage of 14.4%, including a 95% confidence level that the third marketing campaign 803 drove at least 90% of the calculated lift (i.e., 4.8%).

The lift contribution of one or more additional independent variables may be calculated by the statistical modeling computer system 101 using similar econometric model techniques. In this example an independent variable 804 is determined by the system 101 to be a positive driver of the difference in the dependent variable between the matched sets of priority markets and dim markets, with a lift contribution of 5.1%. Four additional independent variables 805-808 were identified as negative drivers in this example, and the system 101 has calculated negative lift contribution percentages of −13.8%, −14.2%, −0.7%, and −2.3%, respectively, for the four negative drivers 805-808. Finally, the econometric modeling techniques performed by the statistical modeling computer system 101 did not determine the one or more additional unknown independent variables 809, which when combined are responsible for the remaining positive lift contribution of 4.5%. The final column 810 in chart indicates a total lift of 100%, which is the sum of the individual drivers 801-808, and corresponds to the entire difference in the dependent variable between the matched sets of priority markets and dim markets.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure.

What is claimed is:

1. A system, comprising:
at least one processor; and
memory storing computer-readable instructions that, when executed by the at least one processor, cause the system to:
identify a dependent variable associated with a marketing campaign;
receive data corresponding to the dependent variable for a plurality of markets over a first period of time prior to the marketing campaign, wherein the plurality of markets comprises one or more priority markets and one or more non-priority markets;
perform a market matching process on the plurality of markets to determine a first set of one or more priority markets and a matching second set of one or more non-priority markets for the dependent variable over the first period of time;
calculate a difference between the first set of markets and the second set of markets for the dependent variable over a second period of time during the marketing campaign;
perform an econometric modeling process on the difference between the first set of markets and the second set of markets for the dependent variable over the second period of time; and
calculate, based on the econometric modeling process, a value representing the contribution of the marketing campaign to the difference between the first set of markets and the second set of markets for the dependent variable over the second period of time.

2. The system of claim 1, wherein the marketing campaign is a mass media marketing campaign associated with a financial institution, and wherein the dependent variable corresponds to sales of a consumer product of the financial institution.

3. The system of claim 1, wherein the one or more non-priority markets correspond to markets in which a baseline spending level was spent on a first type of mass media in the marketing campaign over the second period of time, and wherein the one or more priority markets correspond to markets in which an additional amount greater than the baseline spending level was spent on the first type of mass media for the marketing campaign.

4. The system of claim 1, wherein performing the econometric modeling process comprises:
identifying a first independent variable driving the difference between the first set of markets and the second set of markets for the dependent variable over the second period of time, wherein the first independent variable is an independent variable other than the marketing campaign, and wherein the first independent variable affected the dependent variable prior to the commencement of the marketing campaign.

5. The system of claim 4, wherein performing the econometric modeling process further comprises:
identifying a second independent variable driving the difference between the first set of markets and the second set of markets for the dependent variable over the second period of time, wherein the second independent variable is an independent variable other than the marketing campaign, and wherein the second independent variable did not affect the dependent variable prior to the commencement of the marketing campaign.

6. The system of claim 5, wherein performing the econometric modeling process further comprises:
calculating a first percentage of the difference between the first set of markets and the second set of markets for the dependent variable over the second period of time that is attributable to the first independent variable; and
calculating a second percentage of the difference between the first set of markets and the second set of markets for the dependent variable over the second period of time that is attributable to the second independent variable.

7. The system of claim 1, wherein performing the market matching process comprises:
creating and storing an index of the dependent variable for each of the plurality of markets over the first period of time; and
comparing the stored indexes of the dependent variable for each of the one or more priority markets to the stored indexes of the dependent variable for each of the one or more non-priority markets.

8. The system of claim 1, wherein performing the econometric modeling process comprises:
creating and storing an index of the difference between the first set of markets and the second set of markets for the dependent variable over the second period of time; and
comparing the stored index to a difference in the amount of money spent in the first set of markets and the second set of markets over the second period of time.

9. One or more non-transitory computer-readable media, storing computer-executable instructions that, when executed by a processor, cause a computing device to:
identify a dependent variable associated with a marketing campaign;
receive data corresponding to the dependent variable for a plurality of markets over a first period of time prior to the marketing campaign, wherein the plurality of markets comprises one or more priority markets and one or more non-priority markets;
perform a market matching process on the plurality of markets to determine a first set of one or more priority markets and a matching second set of one or more non-priority markets for the dependent variable over the first period of time;
calculate a difference between the first set of markets and the second set of markets for the dependent variable over a second period of time during the marketing campaign;
perform an econometric modeling process on the difference between the first set of markets and the second set of markets for the dependent variable over the second period of time; and
calculate, based on the econometric modeling process, a value representing the contribution of the marketing campaign to the difference between the first set of markets and the second set of markets for the dependent variable over the second period of time.

10. The one or more non-transitory computer-readable media of claim 9, wherein the marketing campaign is a mass media marketing campaign associated with a financial institution, and wherein the dependent variable corresponds to sales of a consumer product of the financial institution.

11. The one or more non-transitory computer-readable media of claim 9, wherein performing the econometric modeling process comprises:
identifying a first independent variable driving the difference between the first set of markets and the second set of markets for the dependent variable over the second period of time, wherein the first independent variable is an independent variable other than the marketing campaign, and wherein the first independent variable affected the dependent variable prior to the commencement of the marketing campaign.

12. The one or more non-transitory computer-readable media of claim 11, wherein performing the econometric modeling process further comprises:
identifying a second independent variable driving the difference between the first set of markets and the second set of markets for the dependent variable over the second period of time, wherein the second independent variable is an independent variable other than the marketing campaign, and wherein the second independent variable did not affect the dependent variable prior to the commencement of the marketing campaign.

13. The one or more non-transitory computer-readable media of claim 9, wherein performing the market matching process comprises:
creating and storing an index of the dependent variable for each of the plurality of markets over the first period of time; and
comparing the stored indexes of the dependent variable for each of the one or more priority markets to the stored indexes of the dependent variable for each of the one or more non-priority markets.

14. The one or more non-transitory computer-readable media of claim 9, wherein performing the econometric modeling process comprises:
creating and storing an index of the difference between the first set of markets and the second set of markets for the dependent variable over the second period of time; and
comparing the stored index to a difference in the amount of money spent in the first set of markets and the second set of markets over the second period of time.

15. A method, comprising:
identifying, by a computer modeling system, a dependent variable associated with a marketing campaign;
receiving, by the computer modeling system, data corresponding to the dependent variable for a plurality of markets over a first period of time prior to the marketing campaign, wherein the plurality of markets comprises one or more priority markets and one or more non-priority markets;
performing, by the computer modeling system, a market matching process on the plurality of markets to determine a first set of one or more priority markets and a matching second set of one or more non-priority markets for the dependent variable over the first period of time;
calculating, by the computer modeling system, a difference between the first set of markets and the second set of markets for the dependent variable over a second period of time during the marketing campaign;
performing, by the computer modeling system, an econometric modeling process on the difference between the first set of markets and the second set of markets for the dependent variable over the second period of time; and
calculating, by the computer modeling system, based on the econometric modeling process, a value representing the contribution of the marketing campaign to the difference between the first set of markets and the second set of markets for the dependent variable over the second period of time.

16. The method of claim 15, wherein the marketing campaign is a mass media marketing campaign associated with a financial institution, and wherein the dependent variable corresponds to sales of a consumer product of the financial institution.

17. The method of claim 15, wherein performing the econometric modeling process comprises:
identifying a first independent variable driving the difference between the first set of markets and the second set of markets for the dependent variable over the second period of time, wherein the first independent variable is an independent variable other than the marketing campaign, and wherein the first independent variable affected the dependent variable prior to the commencement of the marketing campaign.

18. The method of claim 17, wherein performing the econometric modeling process further comprises:
identifying a second independent variable driving the difference between the first set of markets and the second set of markets for the dependent variable over the second period of time, wherein the second independent variable is an independent variable other than the marketing campaign, and wherein the second independent variable did not affect the dependent variable prior to the commencement of the marketing campaign.

19. The method of claim 15, wherein performing the market matching process comprises:
creating and storing an index of the dependent variable for each of the plurality of markets over the first period of time; and
comparing the stored indexes of the dependent variable for each of the one or more priority markets to the stored indexes of the dependent variable for each of the one or more non-priority markets.

20. The method of claim 15, wherein performing the econometric modeling process comprises:
creating and storing an index of the difference between the first set of markets and the second set of markets for the dependent variable over the second period of time; and
comparing the stored index to a difference in the amount of money spent in the first set of markets and the second set of markets over the second period of time.
